(19) United States
(12) Patent Application Publication
(10) Pub. No.: US 2010/0038358 A1
(43) Pub. Date: Feb. 18, 2010

(54) INDUCTIVE SOLDERING DEVICE

(76) Inventors: Brad M. Dingle, Red Lion, PA (US); Brian S. Micciche, York, PA (US); Shawn M. Sidelinger, York, PA (US); Kenneth A. Neidert, Lewisberry, PA (US); Claudio Meisser, Cham (CH)

Correspondence Address: FRASER CLEMENS MARTIN & MILLER LLC, 28366 KENSINGTON LANE, PERRYSBURG, OH, 43551, US

(21) Appl. No.: 12/533,234

(22) Filed: Jul. 31, 2009

Related U.S. Application Data
(63) Continuation-in-part of application No. 12/408,054, filed on Mar. 20, 2009.
(60) Provisional application No. 61/038,161, filed on Mar. 20, 2008.

(51) Int. Cl. B23K 1/002

(52) U.S. Cl. 219/616

(57) ABSTRACT

A soldering apparatus for connecting solar cells includes an induction heat source to connect cell conducting tracks, provided with soldering medium, with electric conductors. The heat source has a high-frequency generator and an inductor loop in which the flow of a high-frequency current causes a high-frequency magnetic field to induce in the conducting track and in the electric conductor arranged along the conducting track eddy currents that generate the heat that is necessary for the soldering operation. The inductor loop includes a U-shaped loop element that has narrowings and widening in one arm that is positioned closer to the conductor. Ferrite beads and ferrite tubes at the widening concentrate the magnetic field to optimize the heat development in the soldering zone and thus also save energy.

### CROSS-REFERENCE TO RELATED APPLICATION

This application is a continuation-in-part of U.S. patent application Ser. No. 12/408,054, filed Mar. 20, 2009, which claims the benefit of U.S. provisional patent application Ser. No. 61/038,161 filed Mar. 20, 2008.

### FIELD OF THE INVENTION

The invention relates to an inductive soldering device used to generate heat for the soldering process to connect silicon solar cells with flat copper wires.

### BACKGROUND OF THE INVENTION

From Production of crystalline photovoltaic modules is done by electrically connecting groups of silicon solar cells. Typically, individual cells are connected by flat copper wires (ribbons) into electrical series arrangements known as strings. The cell to cell stringing connections are ordinarily done using a soldering process to attach the flat copper wires to the front and back surfaces of the cells.

A general concept of a method and apparatus for forming a solar cell string by inductive soldering is disclosed in EP 1 748 495 A1. From the patent specification EP 1 748 495 A1 a soldering apparatus for the electrical connection of a plurality of solar cells has become known wherein provided on the surface of the cells are conducting tracks which can have applied to them an electrically conducting strip. The strip, by means of a heat source, is electrically connectable with the conducting track, and by means of inductive heating the heat source heats the conducting tracks and strip and melts a soldering medium that connects the strip with the conducting tracks.

In a particular method of soldering, used on Komax stringing machines (Komax AG, Dierikon, Switzerland), the pre-tinned flat copper wires are kept in position by hold-down pins and the heat is generated by water-cooled inductive coils placed near the solar cell. The necessary hold-down pins and inductive coils for the soldering of one solar cell are combined in one device, the so called solder head. The vertically movable solder head is placed over an apparatus maintaining the alignment of the cells and the wires.

When the solder head is lowered, the vertically free movable hold-down pins provide the hold-down force by their weight. Depending on the dimension of the solar cell and the number of flat wires to be connected a considerable number of inductive coils and hold-down pins have to be integrated into the solder head. Each inductive coil needs associated control hardware for power supply and the cooling circuit.

Examples of Komax stringing machines are shown in U.S. Pat. No. 6,510,940 B1 and U.S. Patent Application Publication No. 2006/0219352 A1.

Today's “standard” coil has openings through which the ceramic hold-down pins pass to allow fixing of the ribbon during soldering. Active portions of the coil are symmetrically located on each side of the ribbon, and the level of coil activity in the copper tubing cancels when the tubes come close together. The most active parts of the coil are therefore not over the ribbon such that a large amount of the energy developed is in the cell's metal layer, and not in the copper ribbon. This means that a significant amount of the heat generated has to flow through the cell to reach the ribbon, where it will melt the solder.

### SUMMARY OF THE INVENTION

The present invention relates to a soldering apparatus that generates heat for the soldering process by the induction principle.

An advantage achieved by the invention is the reducing of the cell breakage rates by developing a coil that concentrates its energy into the copper ribbon as much as possible instead of into the metal layer of the solar cell. In this way, the soldering process can be improved by heating more directly the material that needs to receive the heat instead of heating the cell's metal layer and relying on the heat to flow from it. The benefit to users is that they can now solder with even less heat in the cell than with currently available coils.

Another advantage of the present invention is that it reduces the influence of the different thermal expansions of the silicon solar cells and the flat wires. This is achieved by arranging multiple coils orthogonal to the elongations of the flat wires. The coils are activated one after another with a time lag during the soldering process.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a schematic perspective view of a plurality of solar cells that are electrically connected into a cell string;

FIG. 2 is a perspective view of a soldering head with an inductor loop;

FIG. 3 is a perspective view the inductor loop shown in FIG. 2 with a pressure foot;

FIG. 4 is a perspective view and FIG. 5 is a plan view of the inductor loop shown in FIG. 3 whose effective length is settable;

FIG. 5a is a plan view of an alternate embodiment of the inductor loop shown in FIG. 5;

FIG. 6 is an enlarged perspective view of the connecting piece of the inductor loop shown in FIG. 3;

FIG. 7 is a perspective view of a prior art soldering head having induction coils level with and parallel to the upper surface of the solar cell;

FIG. 8 is a perspective view an inductor coil according to the present invention in a lowered position;

FIG. 9 is a perspective view the inductor coil shown in FIG. 8 in an upper position;

FIG. 10 is an end elevation view of the inductor coil shown in FIG. 8;

FIG. 11 is a perspective view an alternate embodiment of an inductor coil according to the present invention;

FIG. 12 is an elevation view of the inductor coil shown in FIG. 11;

FIG. 13 is a perspective view of plurality of the inductor coils shown in FIG. 11 with coil holder blocks; and

FIG. 14 is a block diagram of a control system for multiple inductor coils according to the present invention.

### DESCRIPTION OF THE PREFERRED EMBODIMENT

The U.S. provisional patent application Ser. No. 61/038,161, filed Mar. 20, 2008, and the U.S. patent application Ser. No. 12/408,054, filed Mar. 20, 2009, are hereby incorporated herein by reference.

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

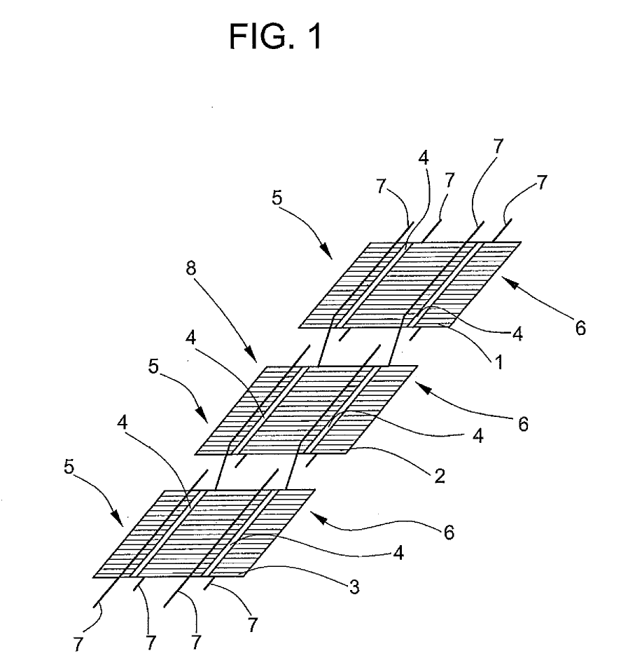

FIG. 1 shows a first solar cell 1, a second solar cell 2, and a third solar cell 3. The solar cells 1, 2, 3 are also referred to as photovoltaic cells and convert the radiant energy contained in light into electrical energy. The voltage that is generated in the individual cells prevails between conducting tracks 4 of the cell upper side 5 and conducting tracks of the lower side 6 of the cell that are not visible in FIG. 1. If the conducting tracks 4 of the cell upper side 5 and the conducting tracks of the cell lower side 6 are connected in a circuit to an electric load, for example an ohmic resistance or battery, an electric current flows, and the energy that is generated by the solar cell is consumed in the load or stored in the battery respectively. A plurality of solar cells is electrically connected together into a string. A plurality of strings form a module, also referred to as a panel. On the conducting tracks 4 of the cell upper side 5, and on the conducting tracks of the cell under side 6, the solar cells are connected in series. The voltages of the individual cells thus add, and thinner conductors 7 can be used for connecting them together.

In FIG. 1 the first solar cell 1, the second solar cell 2, and the third solar cell 3 are electrically connected together into a cell string 8. A conductor 7 connects a conducting track 4 of the cell upper side 5 of the first solar cell 1 with the conducting track of the cell lower side 6 of the second solar cell 2. A conductor 7 connects a conducting track 4 of the cell upper side 5 of the second solar cell 2 with the conducting track of the cell lower side 6 of the third solar cell 3.

The connection between the conducting track 4 and the conductor 7 is produced by means of a soldering operation, wherein a heat source heats the conductor 7 and the conducting track 4 that is provided with soldering medium, and the soldering medium, for example a soft solder, melts, the liquid soldering medium wetting the conducting track 4 and the conductor 7. Under the effect of the heat, a solid electrically conducting connection comes into being between the conducting track 4 and the conductor 7.

To produce the soldered connection, different types of heat generation can be used. As stated above, particularly advantageous is a heat source that operates on the induction principle, wherein a high-frequency generator generates a high-frequency current with a frequency of, for example, 800 kHz to 900 kHz in an inductor loop, which gives rise to a high-frequency magnetic field.

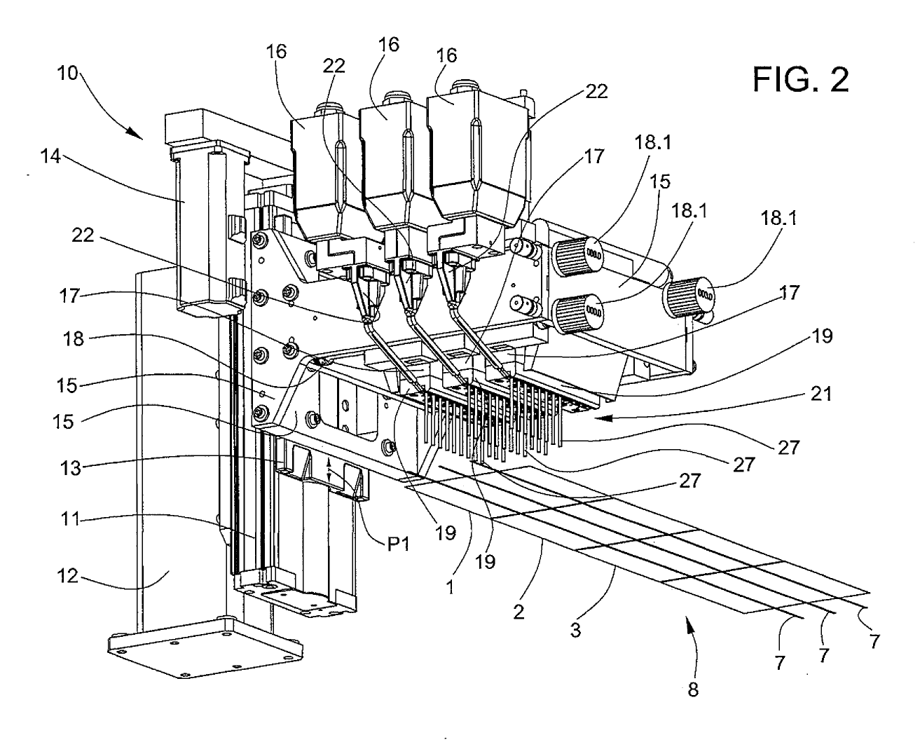

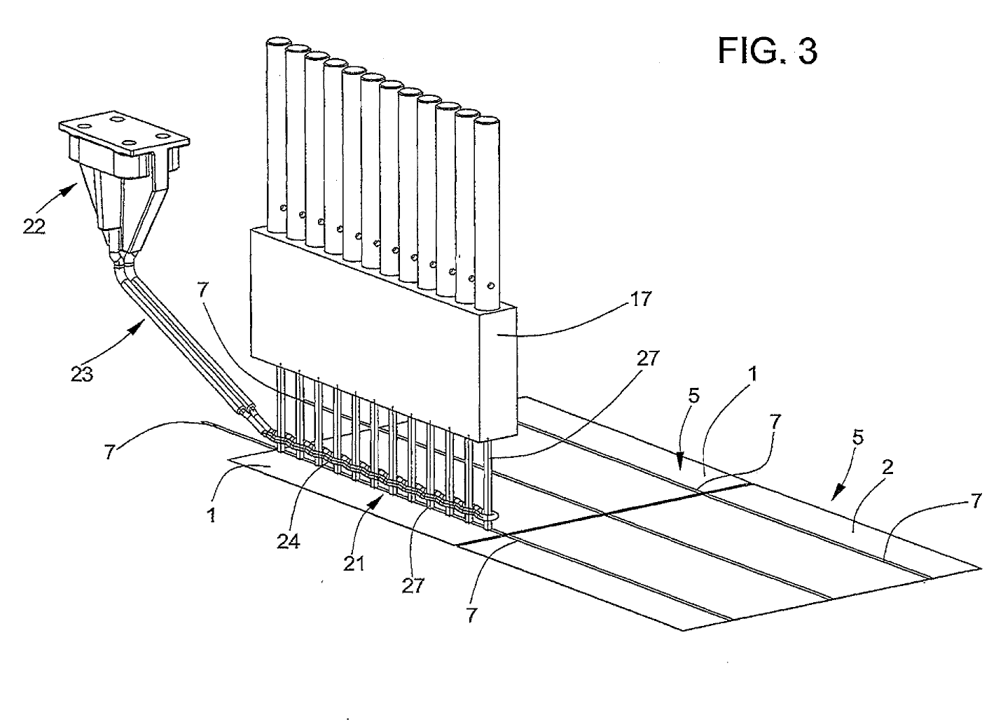

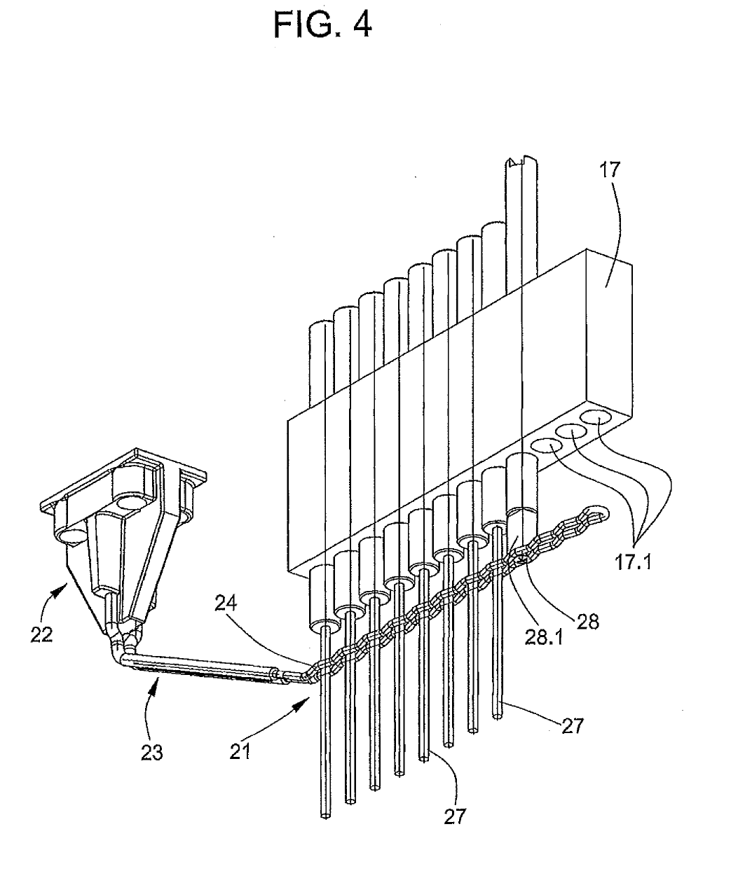

FIG. 2 shows a soldering head 10 equipped with three inductor loops 21. A linear guide 11 is arranged on a stand 12, the linear guide 11 of the guide serving as a slide 13 which, by means of a motor 14, is movable up and down as symbolized with an arrow P1. The slide 13 serves as support for a housing 15, arranged on which are connecting blocks 16, guide blocks 17, an adjusting spindle 18 for the inductor loops 21, and pressure feet 27. Provided for each inductor loop 21 is an adjusting spindle 18, by means of which, with an adjusting nut 18.1, the position of the inductor loop 21 and of the pressure foot 27 is manually alignable on the respective conducting track 4 of the solar cell. The loop element 24 is set into a plate 19, for example of plastic, which is arranged on the guide block 17 (FIG. 3). Each pressure foot 27 is freely movable in a vertical drilled hole 17.1 in the guide block 17 (FIG. 4). When the soldering head 10 is lowered in the direction of the solar cell 1, 2, 3, the pressure feet 27 rest on the conductor 7 and, through their own weight, press the conductor 7 onto the conducting track 4.

FIG. 2 shows the solar cells with three parallel conducting tracks 4. With the soldering head 10 shown, by means of the three inductor loops 21 the three conducting tracks 4 can be soldered simultaneously along their entire cell length.

If solar cells with two conducting tracks 4 are processed or soldered, a connecting block 16, a guide block 17 with the inductor loop 21 and the pressure foot 27 are removed. For solar cells with more than three conducting tracks 4, the soldering head 10 can also be constructed larger than shown, and have more than three inductor loops 21.

The connecting block 16 serves as a support for the inductor loop 21 and comprises the water connection, the electric connection, and the high-frequency generator for generating the high-frequency current in the inductor loop 21.

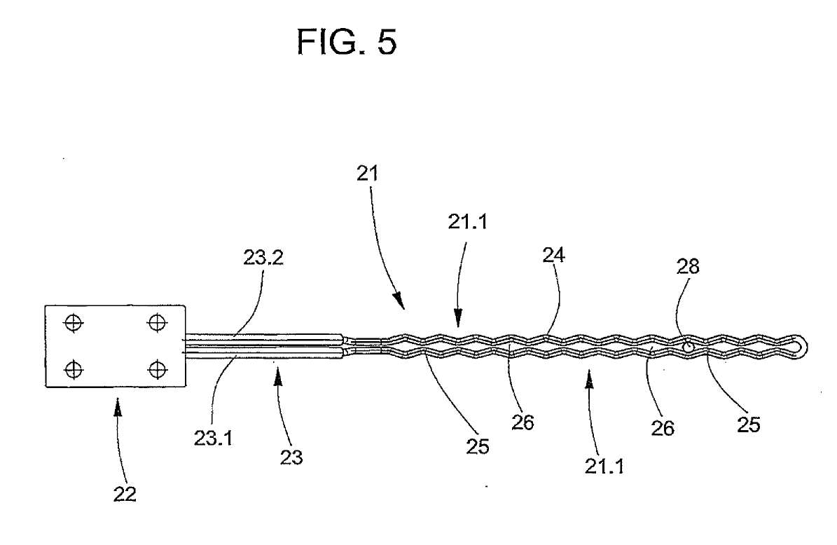

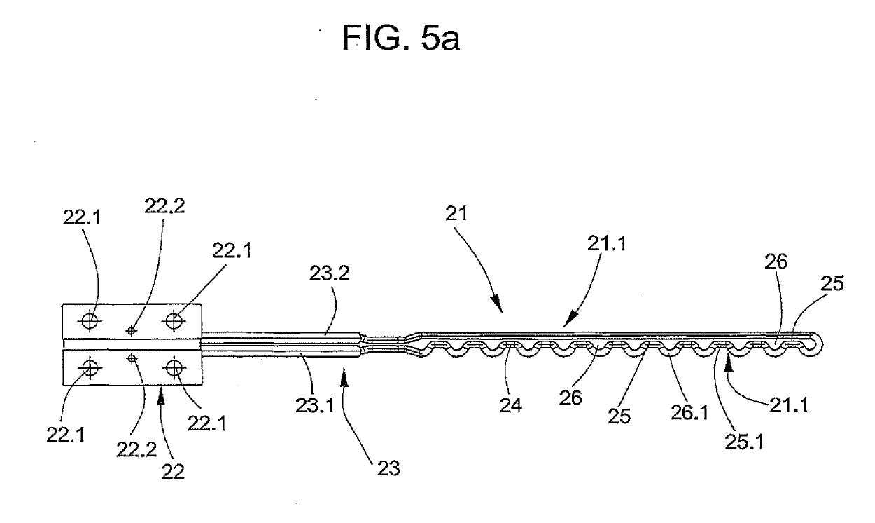

FIG. 3 shows an inductor loop 21, without the plate 19, that is arranged on the soldering head 10. The inductor loop 21 consists of a connecting piece 22, a feeder element 23, and of a U-shaped loop piece 24, at least one arm of the “U” being wavy. The feeder element 23 and the loop element 24 take the form of hollow conductors, and have flowing through them a coolant, for example water. The feeder element 23 consists of two tubes 23.1, 23.2 lying close to each other, which feed the coolant to the loop element 24 and drain it away from the loop element 24 (FIG. 5). The loop element 24 consists of a tube which is formed into a U-shape with two arms 21.1 and closely approximates to the form of a hairpin (FIG. 5). The free ends of the tube are connected with the tubes of the feeder element 23. The tubes of the feeder element 23 and the tube of the loop element 24 are of electrically conducting material as, for example, copper. The U-shaped tube has, as indicated in FIGS. 5, 5a, narrowings 25 and widenings 26. As described further above, the narrowings 25 and widenings 26 serve to optimize the heat development in the solder zone, and thus also the saving of energy. Each widening 26 affords access to the soldering point for a magnetic-field-neutral pressure foot 27 of, for example, ceramic, which presses the conductor 7 onto the conducting track 4. With the inductor loop 21 shown in FIG. 3, the entire length of the conducting track 4 of the cell upper side 5 of a solar cell 1, 2, 3 can be soldered to the conductor 7 in one soldering operation. The magnetic field of the inductor loop 21, or more specifically the eddy currents in the conducting track 4 and in the conductor 7, can also simultaneously heat the conducting track and the conductor, and melt the soldering medium of the cell lower side 6, and produce a soldered joint between the conducting track 4 and the conductor 7.

FIG. 4 and FIG. 5 show the inductor loop 21 whose effective length is settable. The dimensions of the loop element 24 correspond to the dimensions of the loop element 24 of FIG. 3. Depending on need, or depending on the size of the solar cell that is to be soldered, the effective length can be reduced. A screw 28 that is inserted in a widening 26, or a bolt 28 that is inserted in a widening 26, short-circuits the loop element 24. The high-frequency current can flow from the high-frequency generator and generate a magnetic field only as far as the screw or bolt 28. The screw or bolt 28 can be releasably connected with the soldering head and manually or mechanically inserted. The supernumerary pressure feet 27 have been removed, or fixed in a higher position, and a threaded bolt 28.1 for the screw 28 has been inserted in the widening 26 with the drilled hole 17.1 that corresponds to the screw 28.

The form of the widenings 26 and of the narrowings 25 also depends on the manufacturing technology. Critical for optimization of the power consumption is mainly the alternatingly reduced and expanded distance between the tubes. In the example of FIG. 5, the bending radii of the widenings 26 and narrowings 25 are chosen large, so that the loop element 24 can be produced from one tube, in one piece, in one bending operation. If a shape is chosen with small bending radii, for example a zigzag shape, the loop element 24 must be assembled from individual elements for the widening 26 and narrowing 25.

FIG. 5a shows the loop element 24 with a shape which, with respect to the bending radii, can still be produced with one bending operation. The tube, more specifically the one arm 21.1 of the U-shaped loop element 24, is formed straight, and the other leg 21.1 of the loop element 24 is formed wavy with the widenings 26 and the narrowings 26. Provided for the widenings 26 is an arc-shaped section 26.1, and provided for the narrowings 25 is a straight section 25.1, the pressure feet 27 fitting into the widenings 26.

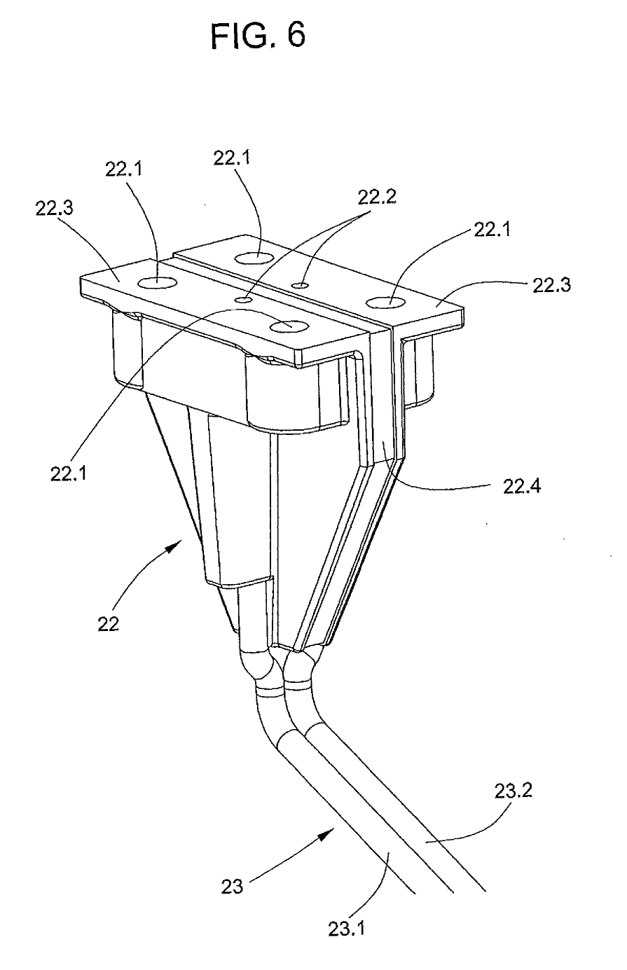

FIG. 6 shows details of the connecting piece 22 of the inductor loop 21. The connecting piece 22 is releasably connected to the connecting block 16 by means of screws that penetrate drilled holes 22.1. The water connection 22.2 is also connected to the connecting block 16 and is sealed by means of a not-shown O-ring at the connector-block end. The coolant circuit for cooling the loop element 24 is thus closed. Electrically, the connecting piece 22 is connected to the connecting block 16 by means of contact surfaces 22.3, the contact surfaces 22.3 being electrically separated be means of an insulation plate 22.4.

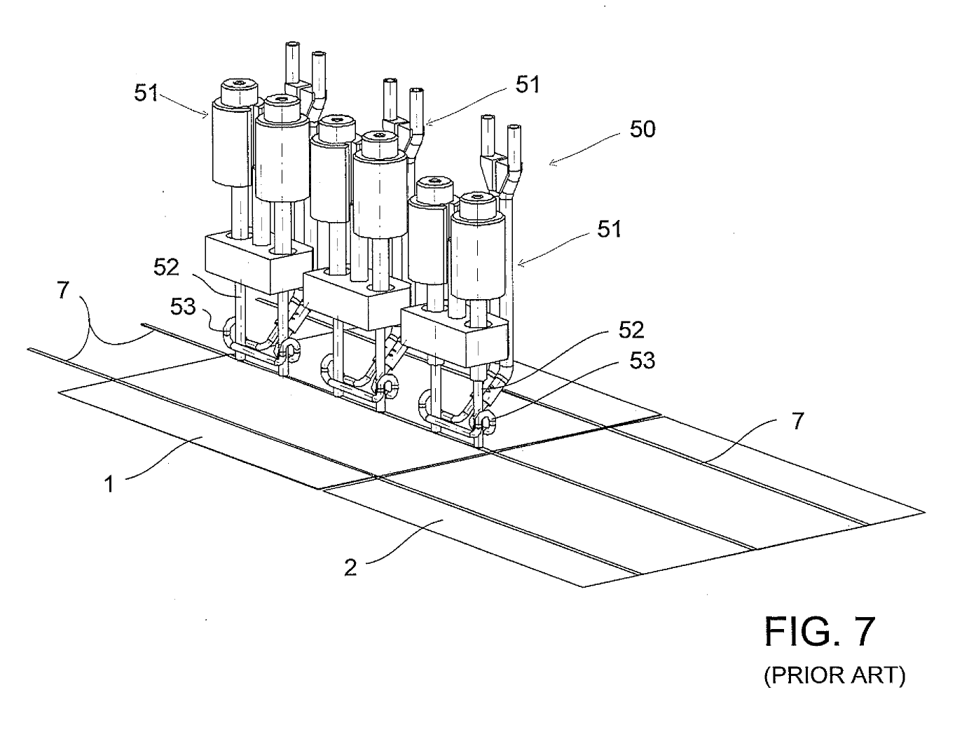

FIG. 7 shows a prior art soldering head 50 equipped with three connecting blocks 51. Each connecting block 51 serves as a support for two hold-down pins or support feet 52 and an inductor loop or coil 53 and comprises the water connection, the electric connection, and the high-frequency generator for generating the high-frequency current in the inductor loop 53.

The coil 53 has openings through which the ceramic hold-down pins 52 pass to allow fixing of the ribbon 7 during soldering. Active portions of the coil 53 are symmetrically located on each side of the ribbon 7, and the level of coil activity in the copper tubing cancels when the tubes come close together. The most active parts of the coil are therefore not over the ribbon 7 such that a large amount of the energy developed is in the cell's metal layer, and not in the copper ribbon. This means that a significant amount of the heat generated has to flow through the cell 8 to reach the ribbon 7, where it will melt the solder.

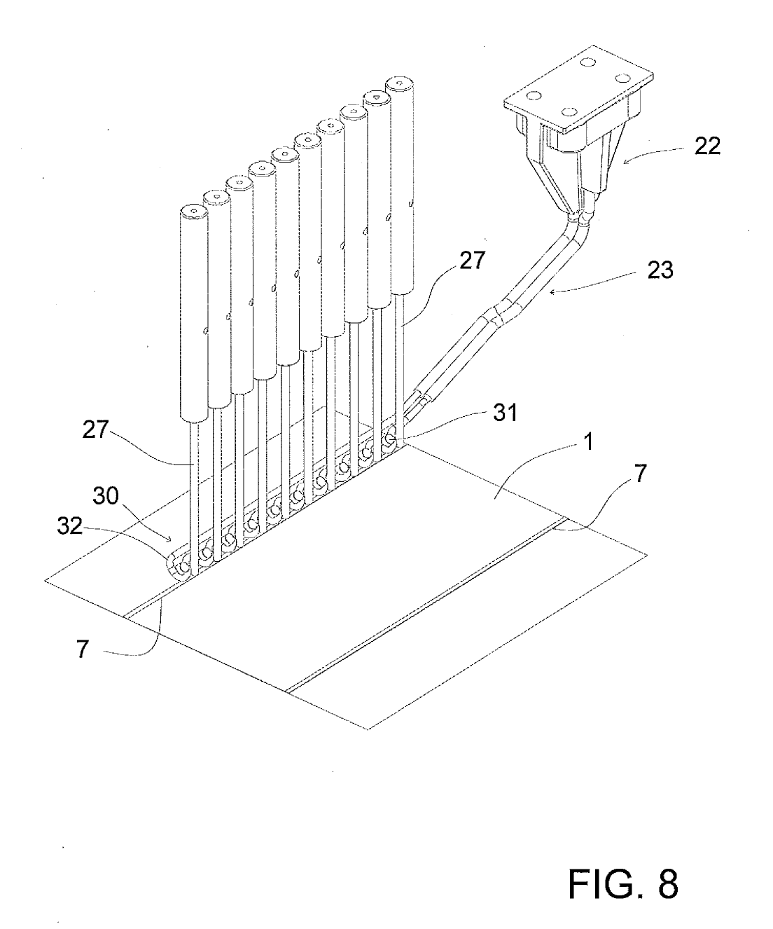

A feature of the present invention is an inductor loop or coil 30 (FIG. 8) having a loop element oriented at a 45 degree angle, in order to apply the heat to the ribbon or conductor 7 and still be able to use the ceramic hold-down pins 27. This allows the pins to work between the active loops of the coil while keeping the rest of the coil far away from the cells 1, 2, 3. Because the new coil 30 has less material in close proximity to the cell than the prior art coil, it is a bit less efficient. To improve the efficiency, a second feature of the present invention adds small beads 31 of ferrite material (flux concentrator) to the insides of each loop of a loop element 32 of the coil 30. FIG. 8 shows the coil 30 in a lowered position for soldering.

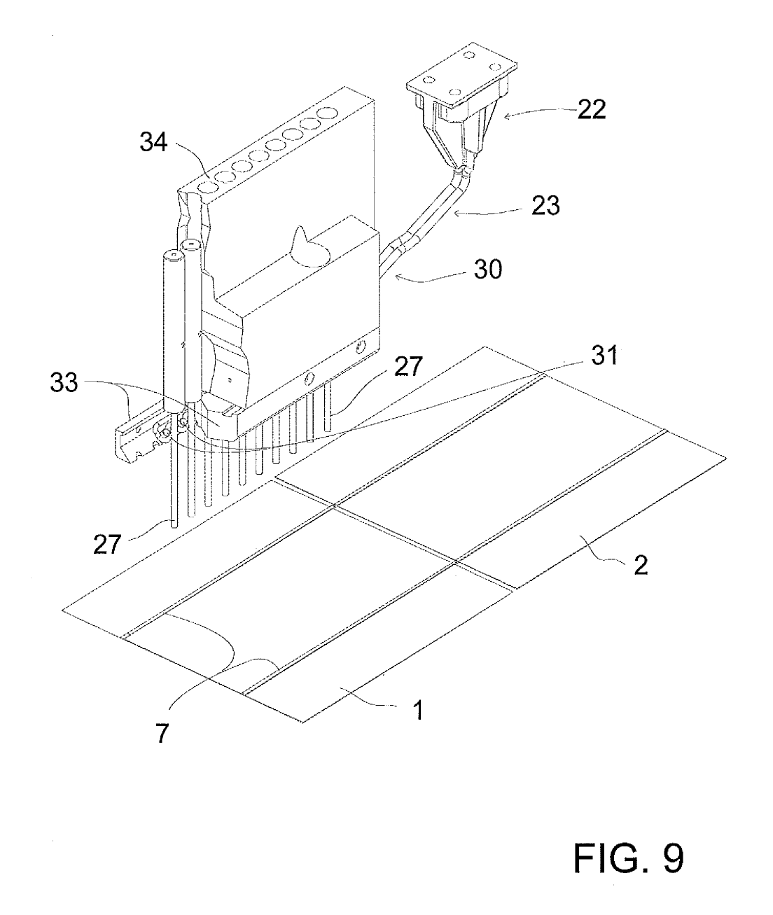

FIG. 9 shows the coil 30 in an upper or raised position in partial cut-away. The beads 31 are mechanically retained in a plastic coil holder block 33 positioned adjacent to a lower end of a guide block 34 for the pins 27. In FIG. 8, the holder block 33 is shown in the lowered position adjacent to the upper surface of the cell 1. The beads 31 function to effectively “force” current generated electromagnetic flux to the opposite side of the coil tube 32. This extra concentration of electromagnetic flux is enough to make the coil's efficiency high enough to allow soldering of solar cells at roughly the same speed as the coil 21.

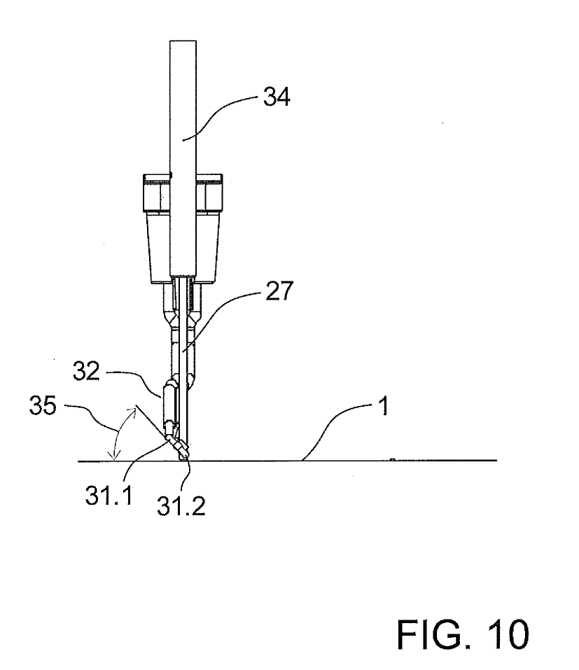

As shown in FIGS. 3 and 5, the arms 21.1 of the coil 21 extend in a horizontal plane parallel to the facing surface of the cell 1. As shown in FIG. 10, the coil 30 is oriented in a plane at a 45 degree angle 35 relative to the facing surface of the cell 1. Similar to the loop element 24 shown in FIG. 5a, the loop element 31 has a straight arm 31.1 and an arm 31.2 with alternating narrowings and widenings. The arm 31.1 is higher than the arm 31.2 such that the widenings are closest to the conductor 7 to concentrate the energy.

The concentration of the energy provided by the inductive coil 30 in “spots” can be used to improve the soldering process. This feature of the present invention is the soldering of sections of more than one ribbon simultaneously when the coil is oriented orthogonally to the ribbons. For the soldering of the whole length of the ribbons several parallel coils are needed. These coils can be activated in a defined sequence to respect the different thermal expansions of the silicon solar cells and the ribbons.

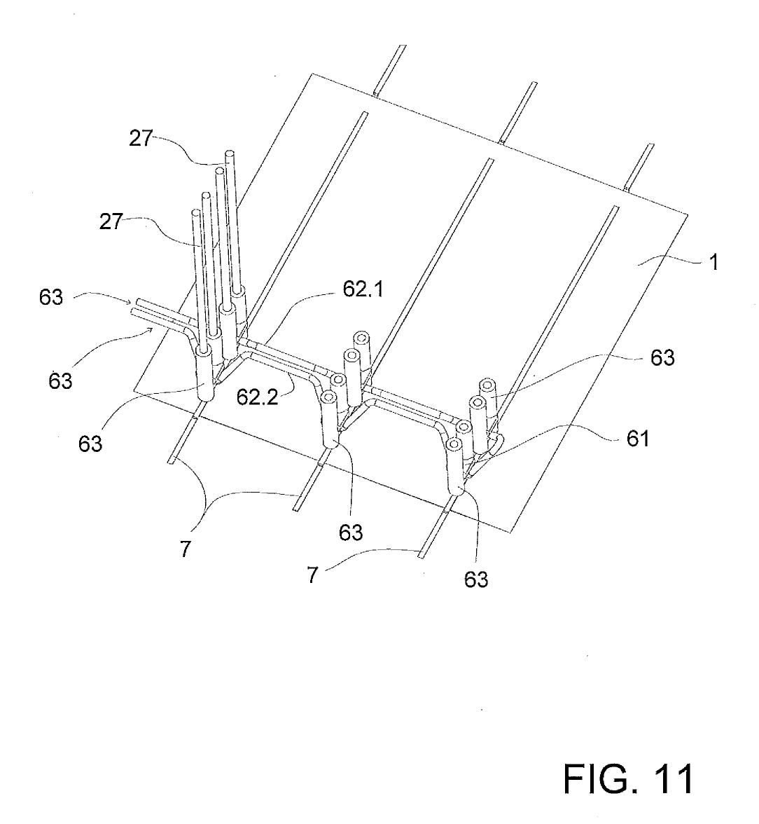

There is shown in FIG. 11 a second embodiment inductor coil 60 for simultaneously soldering sections of at least two of the conductors 7 when used with the connecting piece 22 and the feeder element 23. As shown in FIG. 8 the loop element 32 of the first embodiment coil extends in a longitudinal direction parallel to the longitudinal axis of the conductor 7 being soldered. The coil 60 includes a loop element 62 that extends in a longitudinal direction that is transverse to the longitudinal axis of each of the conductors 7 being soldered. Because of the different orientation of the second type of the coil 60 there are two hold-down pins 27 for each arm of the loop element 62 at each conductor 7. The hold-down pins 27 are placed in tubes 63 made of ferrite material. Ferrite beads 61 are placed between the tubes 63 to concentrate the energy in small spots.

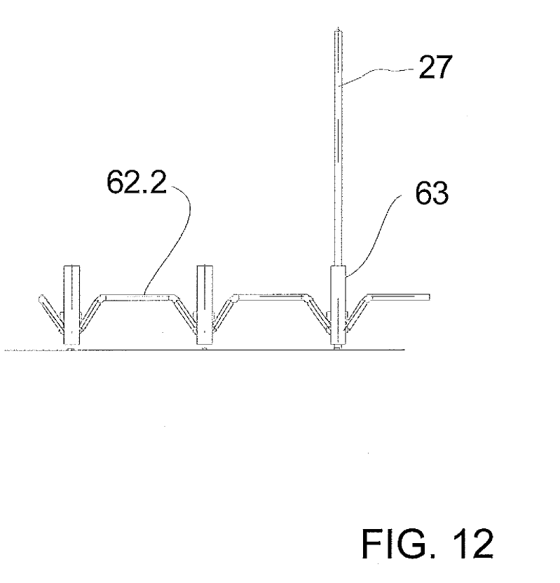

Similar to the first type coil 30, the coil 60 is not oriented in a plane parallel to a solar cell 1. The loop element 62 has a straight arm 62.1 and an arm 62.2 with alternating narrowings and widenings. The loop element 62 is shaped to concentrate the heat in small regions by spacing the straight arm 62.1 and the narrowings of the arm 62.2 farther from the surface of the cell 1 than the widenings of the arm 62.2. As shown in FIG. 12, the widenings of the arm 62.2 extend downwardly and closely adjacent to the surface of the cell 1.

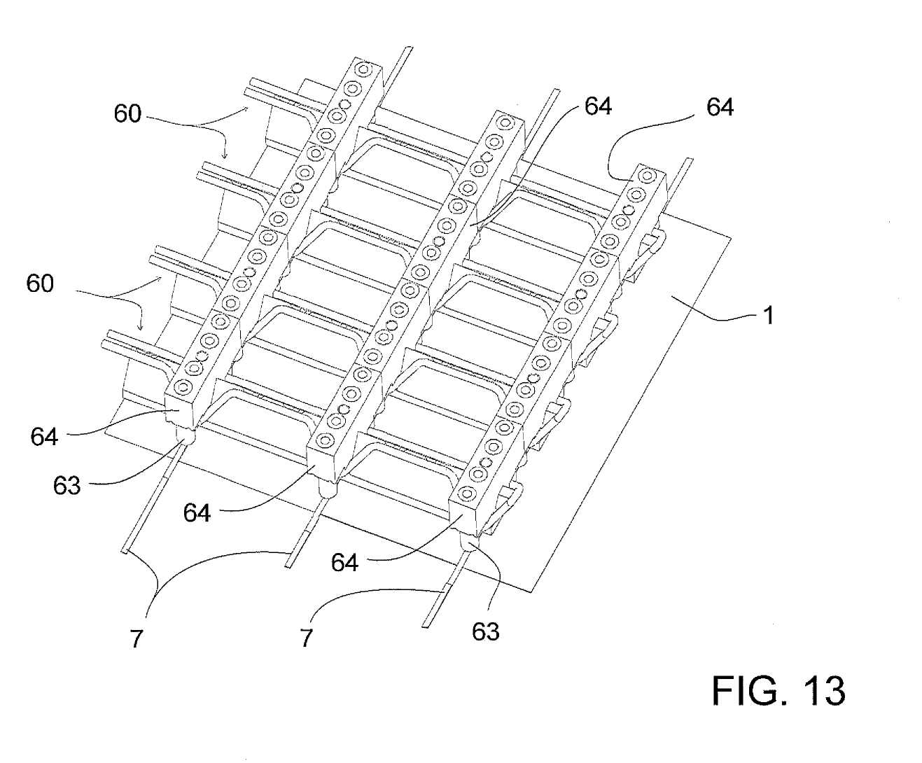

As shown in FIG. 13, a plurality of the coils 60 can be assembled to solder adjacent sections of three of the conductors 7. Each group of four tubes 63 is mounted in a separate plastic coil holder block 64. Although four coils 60 and blocks 64 are shown associated with each of three conductors 7, more or less coils, holders and conductors can be used.

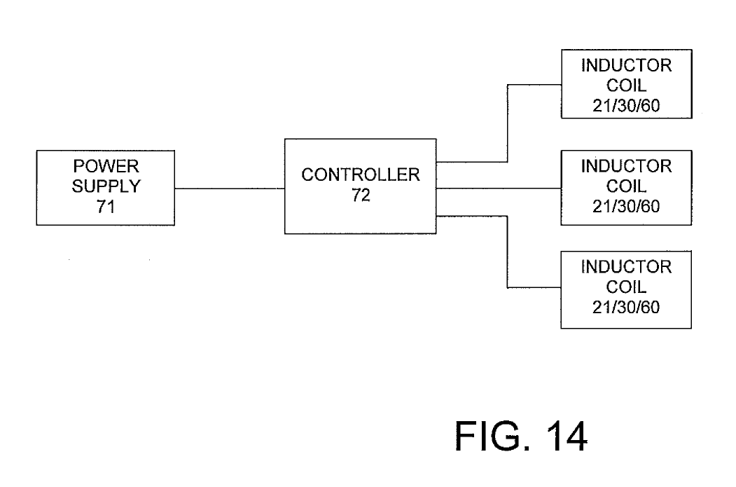

There is shown in FIG. 14 a control system 70 for selectively controlling multiple inductor coils 21, 30 and 60. A power supply 71 is connected to an input of a controller 72 that has individual outputs connected to multiple inductor coils. Although three inductor coils are shown, any number can be connected to the controller 72. The controller can be programmed to activate the coils selectively at different times to solve the problem of the different thermal expansions of the materials to be soldered. For example, if the coil 21 shown in FIG. 3 is replicated side-by-side for the three conductors 7, the controller 72 can active the three coils simultaneously, or active the coils individually in a timed sequence, or activate two of the coils simultaneously and the other coil at a different time. This mode of operation can also be applied to two or more of the inductor coils 30 shown in FIG. 9.

As shown in FIG. 13, the longitudinal axes of the inductor coils 60 extend orthogonal to the longitudinal axes of the conductors 7. As described above, the controller 72 can be operated to active the coils 60 in a timed sequence. For example, the controller 72 can active the four coils 60 sequentially, or active the coils individually or in combinations with any other timed sequence.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A soldering apparatus including a heat source that operates on the induction principle for connecting conducting tracks, that are provided with soldering medium, with electric conductors and including a high-frequency electrical current generator and an inductor loop connected to the generator for receiving a high-frequency electrical current, the inductor loop comprising:
a loop element having a pair of arms extending along parallel longitudinal axes, said arms being selectively positioned at different distances from a surface to which a conductor is to be soldered;
a plurality of hold-down pins for pressing the conductor to the surface; and
a one of said arms closer to the surface has a plurality of widenings whereby each of said hold-down pins passes between said arms at an associated one of said widenings.

2. The soldering apparatus according to claim 1 wherein said arms extend in a plane inclined approximately 45° relative to the surface to which the conductor is to be soldered.

3. The soldering apparatus according to claim 1 including a bead of ferrite material positioned at each said widening wherein flowing of the high-frequency electrical current through said inductor loop generates a high-frequency magnetic field and said beads concentrate the magnetic field at said widenings.

4. The soldering apparatus according to claim 1 including a coil holder block extending along said loop element and retaining said beads.

5. The soldering apparatus according to claim 1 wherein said loop element is formed as a tube in which coolant flows.

6. The soldering apparatus according to claim 1 wherein said inductor loop includes a connecting piece and a feeder element connected between said connecting piece and said loop element.

7. The soldering apparatus according to claim 1 wherein said inductor loop extends transverse to at least two conductors on the surface and wherein one of said widenings is adjacent one of the conductors and another of said widenings is adjacent another of the conductors.

8. The soldering apparatus according to claim 7 including at each said widening one of said arms passes between a first pair of said hold-down pins and another of said arms passes between a second pair of said hold-down pins.

9. The soldering apparatus according to claim 8 including a tube of ferrite material associated with each of said hold-down pins and through which said associated hold-down pin passes.

10. The soldering apparatus according to claim 9 including a bead of ferrite material positioned at each said widening wherein flowing of the high-frequency electrical current through said inductor loop generates a high-frequency magnetic field and said beads concentrate the magnetic field at said widenings.

11. The soldering apparatus according to claim 10 including a coil holder block positioned at each said widening, said coil holders retaining said beads.

12. The soldering apparatus according to claim 1 including a controller connected to the generator wherein the inductor loop is a first inductor loop and the first inductor loop and at least a second inductor loop are connected to said controller, said controller operating to supply the electrical current from the generator to the first inductor loop at a different time than to the second inductor loop.

13. A soldering apparatus for connecting solar cells including a heat source that operates on the induction principle and connects conducting tracks of the solar cells, that are provided with soldering medium, with electric conductors, comprising:
an inductor loop connected to a generator for receiving a high-frequency electrical current, wherein flowing of the high-frequency electrical current through said inductor loop generates a high-frequency magnetic field, said inductor loop including a pair of arms extending along parallel longitudinal axes at different distances from the conducting track to which the electric conductor is to be soldered, a one of said arms having widenings and narrowings spaced along a length thereof; and
a plurality of hold-down pins, each said pin extending between said arms at one of said widenings.

14. The soldering apparatus according to claim 13 wherein said arms extend in a plane inclined approximately 45° relative to a surface to which the conductor is to be soldered.

15. The soldering apparatus according to claim 13 including a bead of ferrite material positioned at each said widening wherein flowing of the high-frequency electrical current through said inductor loop generates a high-frequency magnetic field and said beads concentrate the magnetic field at said widenings.

16. The soldering apparatus according to claim 13 including a coil holder block extending along said loop element and retaining said beads.

17. The soldering apparatus according to claim 13 wherein said inductor loop extends transverse to at least two conductors on the surface and wherein one of said widenings is adjacent one of the conductors and another of said widenings is adjacent another of the conductors.

18. The soldering apparatus according to claim 17 including at each said widening one of said arms passes between a first pair of said hold-down pins and another of said arms passes between a second pair of said hold-down pins.

19. The soldering apparatus according to claim 18 including a tube of ferrite material associated with each of said hold-down pins and through which said associated hold-down pin passes.

20. The soldering apparatus according to claim 19 including a bead of ferrite material positioned at each said widening wherein flowing of the high-frequency electrical current through said inductor loop generates a high-frequency magnetic field and said beads concentrate the magnetic field at said widenings.

21. The soldering apparatus according to claim 20 including a coil holder block positioned at each said widening, said coil holders retaining said beads.

22. The soldering apparatus according to claim 17 including a controller connected to the generator wherein said inductor loop is a first inductor loop and said first inductor loop and at least a second inductor loop extending parallel to said first inductor loop are connected to said controller, said controller operating to supply the electrical current from the generator to said first inductor loop at a different time than to said second inductor loop.

23. A soldering apparatus for connecting solar cells including a heat source that operates on the induction principle and connects conducting tracks of the solar cells, that are provided with soldering medium, with electric conductors, comprising:
at least first and second inductor loops connected to a generator for receiving a high-frequency electrical current, wherein flowing of the high-frequency electrical current through said inductor loops generates a high-frequency magnetic field, each said first and second inductor loop including a pair of arms extending along parallel longitudinal axes at different distances from the conducting track to which the electric conductor is to be soldered, a one of said arms having widenings and narrowings spaced along a length thereof;
a plurality of hold-down pins, each said pin extending between said arms at one of said widening; and
a controller connected between said generator and said first and second inductor loops and operating to supply the electrical current from said generator to said first inductor loop at a different time than to said second inductor loop.
